(19) United States
(12) Patent Application Publication
(10) Pub. No.: US 2007/0180228 A1
(43) Pub. Date: Aug. 2, 2007

(54) Dynamic loading of hardware security modules

(76) Inventor: Ulf Mattsson, Cos Cob, CT (US)

Correspondence Address: FISH & RICHARDSON PC, P.O. BOX 1022, MINNEAPOLIS, MN, 55440-1022, US

(21) Appl. No.: 11/357,351

(22) Filed: Feb. 17, 2006

Related U.S. Application Data
(60) Provisional application No. 60/654,614, filed on Feb. 18, 2005.
(60) Provisional application No. 60/654,145, filed on Feb. 18, 2005.

(51) Int. Cl. H04L 9/00

(52) U.S. Cl. 713/156

(57) ABSTRACT

A system for encrypting data includes, on a hardware cryptography module, receiving a batch that includes a plurality of requests for cryptographic activity; for each request in the batch, performing the requested cryptographic activity, concatenating the results of the requests; and providing the concatenated results as an output.

### RELATED APPLICATION

This application claims priority from co-pending provisional U.S. application Ser. No. 60/654,614, filed Feb. 18, 2005, and to co-pending provisional U.S. application Ser. No. 60/654,145, filed Feb. 18, 2005.

### TECHNICAL FIELD

This invention relates to software and hardware for encrypting data, and in particular, to dynamic loading of a hardware security modules.

### BACKGROUND

Many security standards require use of a hardware security module. Such modules are often capable of executing operations much more rapidly on large data units than they are on small data units. For example, a typical hardware security-module can execute outer cipher block chaining with Triple DES (Data Encryption Standard) operations at over 20 megabytes/second on large data units.

Access to encrypted database tables often requires decryption of data fields and execution of DES operations on short data units (e.g., 8-80 bytes). For DES operations on short data units, commercial hardware security-modules are often benchmarked at less than 2 kilobytes/second.

Over the past several years, teams have worked on producing high-performance, programmable, secure coprocessor platforms as commercial offerings based on cryptographic embedded systems. Such systems can take on different personalities depending on the application programs installed on them. Some of these devices feature hardware cryptographic support for modular math and DES.

Previous efforts have been focused on secure coprocessing. These efforts sought to accelerate DES in those cases in which keys and decisions were under the control of a trusted third party, not a less secure host. An example of such a scenario is re-encryption on a hardware-protected database servers to ensure privacy even against root and database administrator attacks.

### SUMMARY

In general, in one aspect, a system for encrypting data includes, on a hardware cryptography module, receiving a batch that includes a plurality of requests for cryptographic activity; for each request in the batch, performing the requested cryptographic activity, concatenating the results of the requests; and providing the concatenated results as an output.

Some implementations include one or more of the following features. The batch includes an encryption key, and performing the requested cryptographic activity comprises in an application-level process, providing the key and the plurality of requests as an input to a system-level process; and in the system-level process, initializing a cryptography device with the key, using the cryptography device to execute each request in the batch, and breaking chaining of the results. The concatenating of the results is performed by the system level process. Performing the requested cryptographic activity includes in an application-level process, providing the batch as an input to a system-level process; and in the system-level process, for each request in the batch, resetting a cryptography device, and using the cryptography device to execute the request.

The concatenating of the results is performed by the system level process. Each request in the batch includes an index into a key table, and performing the requested cryptographic activity includes, in an application-level process, loading the key table into a memory, and making the key table available to a system-level process; and in the system-level process, resetting a cryptography device, reading parameters from an input queue, loading the parameters into the cryptography device, and for each request in the batch, reading the index, reading a key from the key table in the memory based on the index, loading the key into the cryptography device, reading a data length from the input queue, instructing the input queue to send an amount of data equal to the data length to the cryptography device, and instructing the cryptography device to execute the request and send the results to an output queue. The batch also includes a plurality of parameters associated with the requests, including a data length for each request, and performing the requested cryptographic activity comprises in a system-level process, instructing an input queue to send the parameters into a memory through a memory-mapped operation, reading the batched parameters from the memory, instructing the input queue to send amounts of data equal to the data lengths of each of the requests to a cryptography device based on the parameters, and instructing the cryptography device to execute the requests and send the results to an output queue.

Other general aspects include other combinations of the aspects and features described above and other aspects and features expressed as methods, apparatus, systems, program products, and in other ways.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIGS. 1 and 8-10 are block diagrams of hardware security modules.

FIGS. 2 and 3 are block diagrams of communications between a device and a host.

FIGS. 4-7 are flow charts.

Like reference symbols in the various drawings indicate like elements.

### DETAILED DESCRIPTION

System Setup Configuration

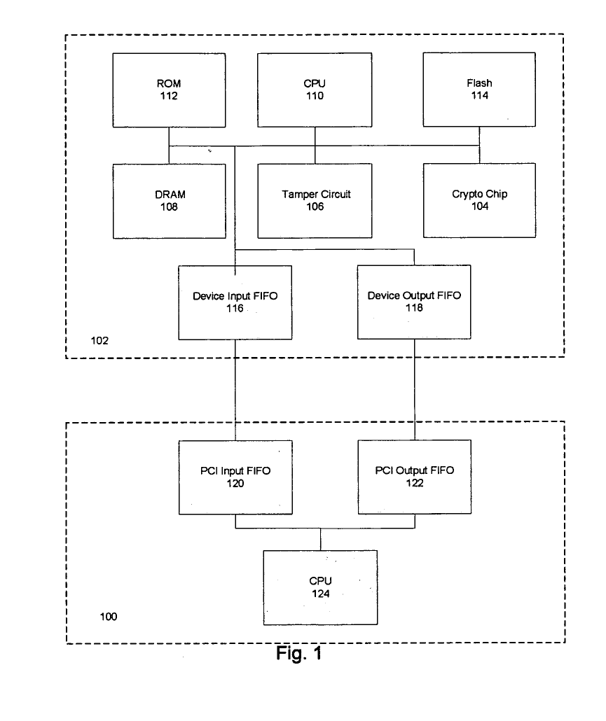

FIG. 1 shows a test device 102 in communication with a host computer 100. As shown in FIG. 1, the test device 102 includes a multi-chip embedded module packaged in a PCI card. The module includes a cryptographic chip 104, circuitry 106 for tamper detection and response, a DRAM module 108, a general-purpose computing environment such as a 486-class CPU 110 executing software loaded from an internal ROM 112 and a flash memory 114. The test device 102 has a device input FIFO queue 116 and a device output FIFO 118 queue in communication with corresponding PCI input and PCI output FIFO queues 120 and 122 in the host computer's PCI bus, which in turn are in communication with the host CPU 124.

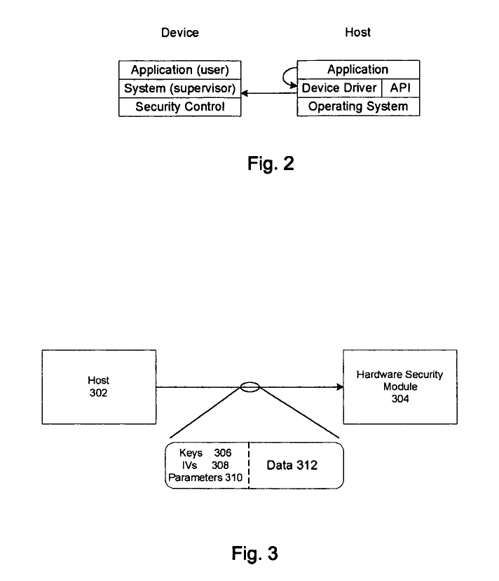

As shown in FIG. 2, the multiple-layer software architecture of test device 102 includes foundational security control, supervisor-level system software, and user-level application software. When a host-side application wants to use a service provided by the card-side application, it issues a call to the host-side device driver. The device driver then opens a request to the system software on the test device 102.

Hardware

The DES performance of the test device 102 was initially benchmarked at approximately 1.5 kilobytes/second. This figure was measured from the host-side application, using a commercial hardware security module. The DES operations selected for the benchmark testing were CBC-encrypt and CBC-decrypt, with data sizes distributed uniformly at random between 8 and 80 bytes. The keys were Triple-DES (TDES)-encrypted with a master key stored inside the device. The Initialization Vectors (initialization vectors) and keys changed with each operation.

As shown in FIG. 3, ancillary data, which includes keys 306, initialization vectors 308, and operational parameters 310 was sent together with the test data 312 from the host 302 to the HSM 304 with each operation. This ancillary data was ignored in evaluating data throughput. Although the keys could change with each operation, the total number of keys (in our sample application, and in others we surveyed) was still fairly small, relative to the number of requests.

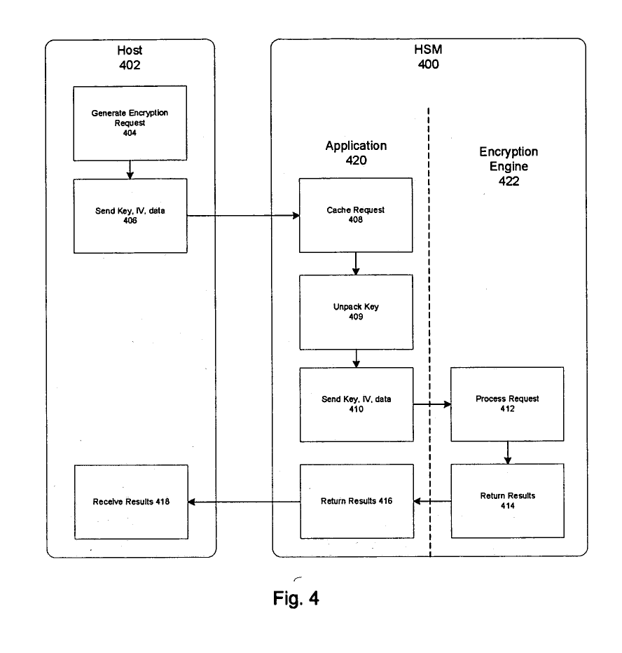

As shown in FIG. 4, an initial baseline implementation includes a host application 402 that generates (step 404) sequences of short-DES requests (cipherkey, initialization vector, data) and sends (step 406) them to a card-side application 420 running on the hardware security module 400. The card-side application 420 caches (step 408) each request, unpacks the key (step 409), and sends (step 410) the data, key, and initialization vector to the encryption engine 422. The encryption engine 422 processes (step 412) the requests and returns (step 414) the results to the card-side application 420. The card side application 420 then forwards these results back to the host application 402 (step 416).

Several solutions were found to improve the encryption speed of small blocks of data.

Reducing Host-Card Interaction

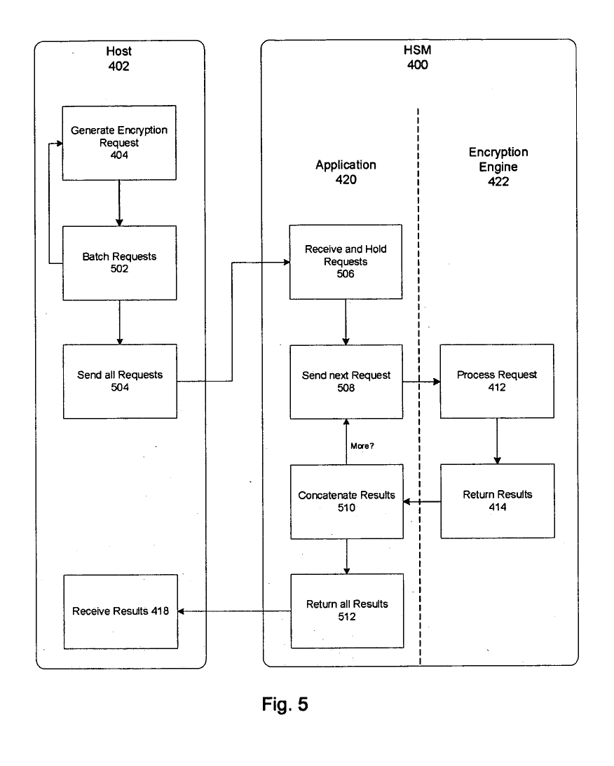

As shown in FIG. 5, to reduce the number of host-card interactions (from one set per each 44 bytes of data, on average), the host-side application 402 is modified to batch (step 502) a sequence of short-DES requests into one request, which is then sent (step 504) to the hardware security module 400. The card-side application 420 is correspondingly modified to receive the sequence from the host-side application in one step 506, and to send each short-DES request to the encryption engine 422 in a repeated step 508. The encryption engine 422 processes (step 412) each request, as described in connection with FIG. 4, and returns (step 414) corresponding results to the card-side application 420. After the concatenation step 510, the card-side application 420 either returns to step 508 for the next request or sends all the completed requests back to the host in a single step 512.

Batching Into One Chip

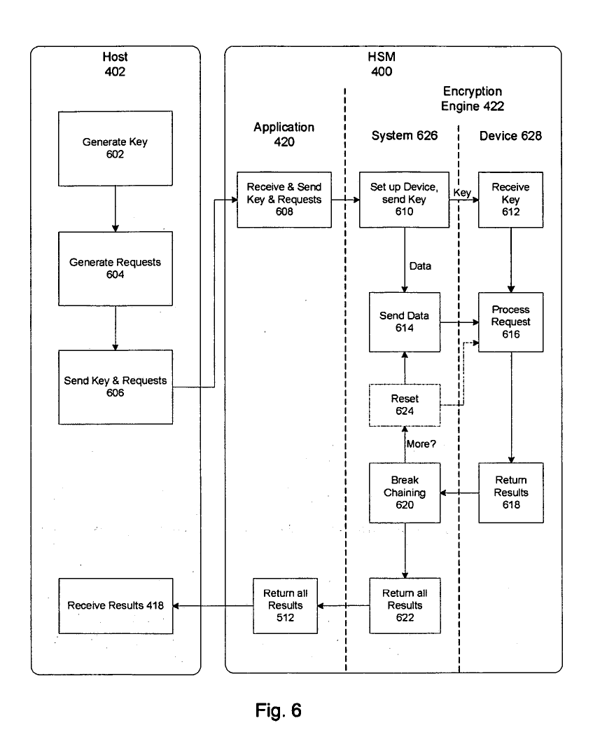

In some examples, the cryptographic chip 104 is reset for each operation (again, once per 44 bytes, on average). Eliminating these resets results in some improvement. As shown in FIG. 6, to eliminate the need for the reset step, a sequence of short-DES operation requests is generated (step 604), all of which use the same previously-generated key and the same pre-determined initialization vector, and all of which make the same request (“decrypt” or “encrypt”). The single key and all the batched requests are sent (step 606) together as an operation sequence to the hardware security module 400. The card-side application 420 receives (step 608) the operation sequence and sends it to the system software 626. The system software 626, for example, a DES Manager controlling DES hardware, is modified to set up the cryptography device 628 with the provided key and initialization vector in one step 610, and to send the data through to the cryptography device 628 in a second step 614. The cryptography device 628 then carries out (step 616) the operation requested. The cryptography device 628 only needs to receive (step 612) the key once. At the end of each operation, the cryptography device 628 returns the results to the system software 626 (step 618), which executes an XOR to break the chaining (step 620).In particular, for encryption, the system software 626 manually XORs the last block of ciphertext from the previous operation with the first block of plaintext for the next operation, in order to cancel out the XOR that the cryptography device 628 would ordinarily have done. The system software then returns (step 622) the results to the card-side application 420, which forwards (step 512) them on to the host application 402.

Batching into Multiple Chip

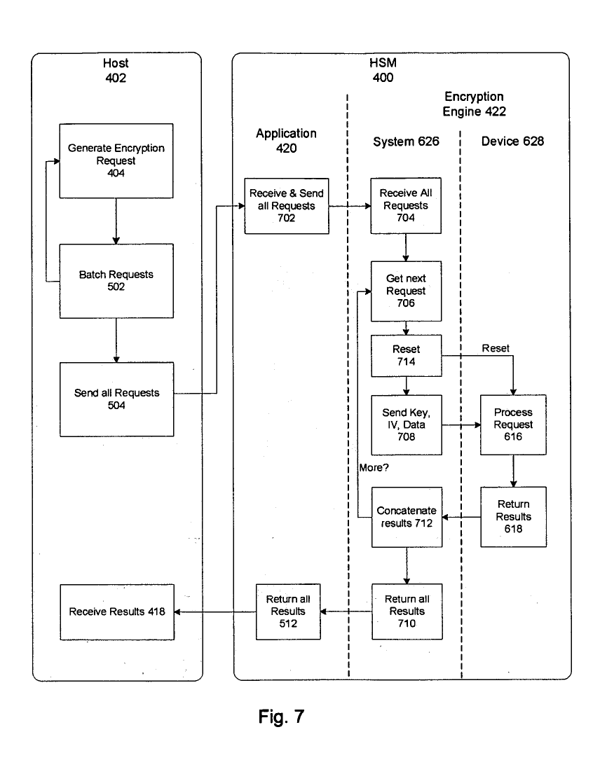

Another significant bottleneck is the number of context switches. As shown in FIG. 7, to reduce the number of context switches, the multi-key, nonzero-initialization vector example discussed in connection with FIG. 5 is repeated, but with the card-side application 420 now being configured to send (step 702) the batched requests to the system software 626. The system software 626 receives (step 704) the requests, takes each in turn (step 706), and resets (step 714) the cryptographic device 628. It then sends (step 708) the key, initialization vector, and data from the current request to the cryptographic device 628 where the request is processed (step 616). The results are returned (step 618) to the system software 626 where they are concatenated (step 712). If more requests remain, the process repeats, otherwise, the results are returned (step 710) to the card-side application 420 which forwards (step 512) them to the host 402.

Reducing Data Transfers

Each short DES operation requires a minimum number of I/O operations: to set up the cryptography chip, to get the initialization vector and keys and forward them to the cryptography chip, and then to either drive the data through the chip, or to let the FIFO state machine pump it through.

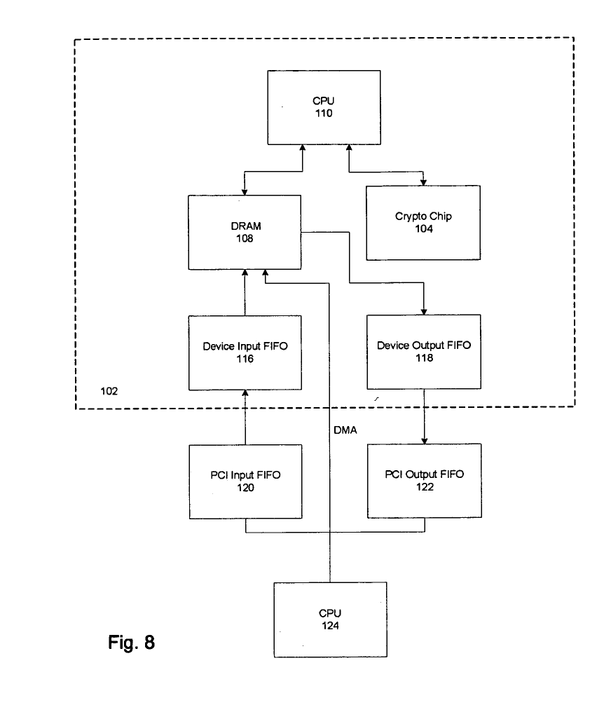

Each byte of key, initialization vector, and data is handled many times. For example, as shown in FIG. 8, the bytes come in via the PCI input FIFO 120 and device input FIFO 116 and via DMA into DRAM 108 with the initial request buffer transfer; the CPU 110 then takes the bytes out of DRAM 108 and puts them into the cryptography chip 104; the CPU 110 then takes the data out of the cryptography chip 104 and puts it back into DRAM 108; the CPU 110 finally sends the data back to the host through the device and PCI output FIFOs 118 and 122, respectively.

In theory, however, each parameter (key, initialization vector, and direction) should require only one transfer, in which the CPU 110 reads it from the device input FIFO 116 and carries out the appropriate procedure. If the FIFO state machine pumps the data bytes through the cryptography chip 104 directly, then the CPU 110 never need handle the data bytes at all. For example, key unpacking can be eliminated,. Instead, within each application, an “initialization” step will place a plaintext key-table in device DRAM 108.

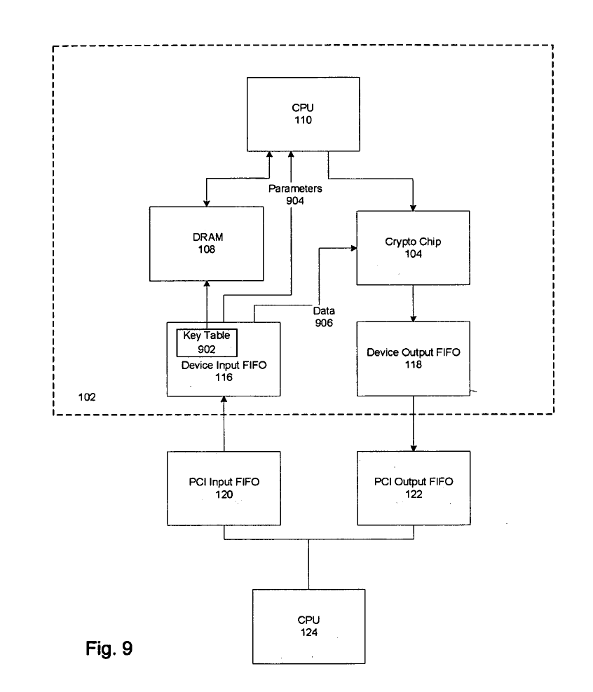

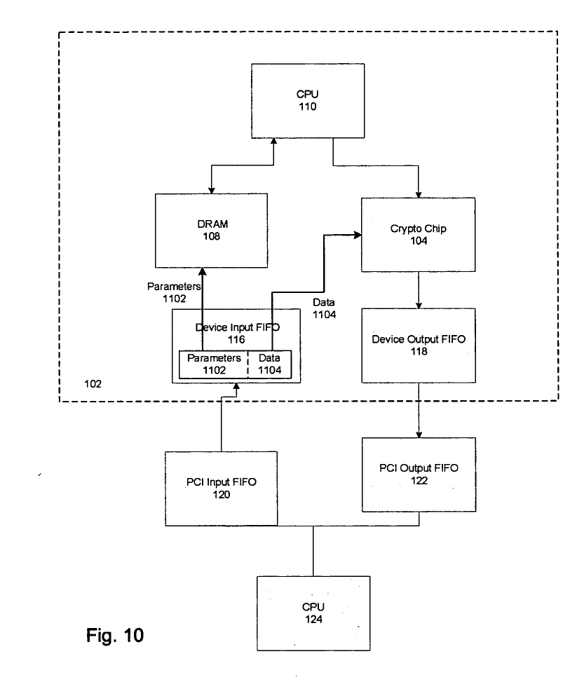

As shown in FIG. 9, the host application is modified to generate sequences of requests, each of which includes an index into an internal key table 902, instead of a cipher key. The card-side application calls the modified system software and makes the key table available to it, rather than immediately bringing the request sequence from the PCI Input FIFO 116 into the DRAM 108. For each operation, the modified system software then resets the cryptography chip 104; reads the initialization vector and other parameters 904 directly from the device input FIFO 116 and loads them into the cryptography chip 104,; reads and confirms the integrity of the key index, looks up the key in the key table 902 in the DRAM 108, and loads the key into the chip 104; reads the data length for this operation; and sets up the state machine in the FIFO to convey a corresponding number of bytes 906 through the input device input FIFO 116 into the cryptography chip 104 and then back out the device output FIFO 118.

Using Memory Mapped I/O

In many cases, the I/O operation speed is limited by the internal ISA bus of the coprocessor, which has an effective transfer speed of 8 megabytes/second. Given the number of fetch-and-store transfers associated with each operation (irrespective of the data length), the slow ISA speed is potentially another bottleneck.

Batching Operation Parameters

The approach of the previous example includes reading the per-operation parameters via slow ISA I/O from the PCI Input FIFO. However, if the parameters are batched together, they can be read via memory-mapped operations, the FIFO configuration can be changed, and the data processed.

For example, as shown in FIG. 11, the host application is modified to batch all the pre-operation parameters 1102 into a single group that is prepended to the input data 1104. The modified system software on the HSM 102 then sets up the device input FIFO 116 and the state-machine to read the batched parameters 1102, by-passing the cryptography chip 104; reads the batched parameters via memory-mapped operations from the device input FIFO 116 into the DRAM 108; reconfigures the FIFOs; and, using the buffered parameters 1102, sets up the state-machine and the cryptography chip 104 to pump each operation's data 1104 from the input FIFO 116, through the chip 104, and then back out the output FIFOs.

Other Techniques To Increase Encryption Efficiency

Improving Per-Batch Overhead

In some examples, for fewer than 1000 operations, the speed is still dominated by the per-batch overhead. In such cases, one can eliminate the per-batch overhead entirely by modifying the host-to-device driver interaction to enable indefinite requests, with some additional polling or signaling to indicate when more data is ready for transfer.

API Approaches.

There are various ways to reduce the per-operation overhead by minimizing the number of per-operation parameter transfers. For example, the host application might, within a batch of operations, interleave “parameter blocks” that assert for example, that the next N operations all use a particular key. This eliminates repeated interaction with the key index. In another example, the host application itself might process the initialization vectors before or after transmitting the data to the card, as appropriate. In this case, there is no compromise with security if the host application already is trusted to provide the initialization vectors. This eliminates bringing in the initialization vectors, and, since the DES chip has a default initialization vector of zeros after reset, eliminates loading the initialization vectors as well.

Hardware Approaches.

Another avenue for reducing per-operation overhead is to change the FIFOs and the state machine. The hardware currently available provides a way to move the data, but not the operational parameters, very quickly through the engine. For example, if the DES engine expects its data-input to include parameters (e.g., “do the next 40 bytes with key #7 and this initialization vector”) interleaved with data, then the per-operation overhead could approach the per-byte overhead. The state machine would be modified to handle the fact that the number of output bytes may be less than the number of input bytes (since the latter include the parameters). The same approach would work for other algorithm engines being driven in the same way, or with different systems for driving the data through the engine.

In some examples, it is also beneficial for the CPU to control or restrict the class of engine operations over which the parameters, possibly chosen externally, are allowed to range. For example, the external entity may be allowed only to choose certain types of encryption operations (restriction on type), or the CPU may wish to insert indirection on the parameters that the external entity chooses and the parameters that the engine sees. In one example, the external entity provides an index into an internal table, as discussed in previous examples.

Application

The various techniques described for increasing the DES operation speeds for small blocks of data can be used to improve the performance of an encrypted database. Certain database transactions can be identified, based on response time statistics, as involving short data blocks. Once identified, such transactions are redirected to a decryption process optimized for decrypting short data blocks.

A database system thus modified includes a dynamic HSM loader having a dynamic HSM loader client executing on a server separated from the database server and the hardware security-module, and a dynamic HSM loader server that executes on the hardware security-module.

During operation of such a system, response time statistics are first collected from observing transactions that access encrypted database tables requiring decryption of short data fields. Then, critical transactions are dynamically re-directed. These critical transactions are those that require particularly short response times.

The dynamic HSM loader first creates an in-memory array of data and security attributes. Then, a database server off-loads database transactions and cryptographic operations to the dynamic HSM loader client, which operates on separated, parallel server clusters. The dynamic HSM loader client holds application data and operates with a limited set of SQL instructions.

The dynamic HSM loader off-loads cryptographic operations to hardware security modules operating on separate, parallel hardware security-module clusters. Then, the dynamic HSM loader batch feeds a large number of data elements, initialization vectors, encryption key labels, and algorithm attributes from the dynamic HSM loader client to the dynamic HSM loader server. The programmability of the hardware security-module enables a dynamic HSM loader server process to run on the hardware security-module.

A number of embodiments of the invention have been described. Nevertheless, it will be understood that various modifications may be made without departing from the spirit and scope of the invention. For example, keys may be loaded from an external source; high-speed short DES applications may be provided the ability to greatly restrict the modes or keys or initialization vectors or other such parameters that an untrusted host-side entity can choose. The techniques discussed in the examples could also speed up TDES, SHA-1, DES-MAC, and other algorithms. Any of the parameters, input, or output could come from or be directed components internal to the system, rather than external. Operations could be sorted in various ways before execution to help speed performance. Accordingly, other embodiments are within the scope of the following claims.

1. A method of encrypting data, comprising:
identifying database requests for cryptographic activity involving short data blocks;
batching the identified requests into a batch comprising a plurality of the identified requests; and
on a hardware cryptography module,
receiving the batch that includes the plurality of requests,
for each request in the batch, performing the requested cryptographic activity, concatenating the results of the request, and
providing the concatenated results as an output.

2. The method of claim 1 in which the batch includes an encryption key, and performing the requested cryptographic activity comprises
in an application-level process,
providing the key and the plurality of requests as an input to a system-level process; and
in the system-level process,
initializing a cryptography device with the key,
using the cryptography device to execute each request in the batch, and
breaking chaining of the results.

3. The method of claim 2 in which the concatenating of the results is performed by the system level process.

4. The method of claim 1 in which performing the requested cryptographic activity comprises
in an application-level process,
providing the batch as an input to a system-level process; and in the system-level process,
for each request in the batch,
resetting a cryptography device, and
using the cryptography device to execute the request.

5. The method of claim 4 in which the concatenating of the results is performed by the system level process.

6. The method of claim 1 in which each request in the batch includes an index into a key table, and performing the requested cryptographic activity comprises
in an application-level process,
loading the key table into a memory, and
making the key table available to a system-level process; and
in the system-level process,
resetting a cryptography device,
reading parameters from an input queue,
loading the parameters into the cryptography device, and
for each request in the batch,
reading the index,
reading a key from the key table in the memory based on the index,
loading the key into the cryptography device,
reading a data length from the input queue,
instructing the input queue to send an amount of data equal to the data length to the cryptography device, and
instructing the cryptography device to execute the request and send the results to an output queue.

7. The method of claim 1 in which the batch also includes a plurality of parameters associated with the requests, including a data length for each request, and performing the requested cryptographic activity comprises
in a system-level process,
instructing an input queue to send the parameters into a memory through a memory-mapped operation,
reading the batched parameters from the memory,
instructing the input queue to send amounts of data equal to the data lengths of each of the requests to a cryptography device based on the parameters, and
instructing the cryptography device to execute the requests and send the results to an output queue.

8. The method of claim 6 further comprising unpacking the key table into plaintext before loading it into the memory.

9. The method of claim 1 in which the batch includes groups of requests with an encryption key for each group, and performing the requested cryptographic activity comprises
in an application-level process,
providing the groups of requests and keys as an input to a system-level process; and
in the system-level process, for each group of requests
initializing a cryptographic device with the key for the group of requests
using the cryptographic device to execute each request in the group, and
breaking the chaining of the results.

10. The method of claim 2 in which the batch further includes processed initialization vectors for performing the requested cryptographic activity.

11. The method of claim 1 wherein the batching step further comprises interleaving operational parameters with the requests.
